(19) United States
(12) Patent Application Publication
(10) Pub. No.: US 2026/0070591 A1
(43) Pub. Date: Mar. 12, 2026

(54) METHOD AND SYSTEM OF DETECTING DEFECTS IN TRACK RAILS

(71) Applicant: L&T TECHNOLOGY SERVICES LIMITED, Chennai (IN)

(72) Inventors: NIRANJAN NAROTTAM KEER, Thane (IN); ARADHYA PRASAD MUKHERJEE, Bokaro Steel (IN); UDAY KIRAN BONTHU, Vizianagaram (IN)

(21) Appl. No.: 19/023,649

(22) Filed: Jan. 16, 2025

(30) Foreign Application Priority Data
Sep. 12, 2024 (IN) 202441069223

(51) Int. Cl. B61L 23/04; B61K 9/08; G06T 7/00

(52) U.S. Cl. CPC B61L 23/042; B61K 9/08; G06T 7/0004; G06T 2207/20081

(57) ABSTRACT

A method and system for detecting defects in track rails is disclosed. A processor receives imaging data of one or more-track rails in real-time using an imaging device coupled to a railway train. A set of image frames of the one or more-track rails are determined for each time instance. A first processed frame is determined from the set of image frames based on detection of at least one first defect from a set of predefined defects in the set of image frames using a first artificial intelligence (AI) model. The first processed frame is processed to determine a second processed frame from the first processed frame based on detection of at least one second defect from the set of predefined defects in the first processed frame using a second AI model.

### TECHNICAL FIELD

This disclosure relates generally to railway track inspection systems and more particularly to a method and system of detecting defects in track rails.

### BACKGROUND

Railway infrastructure plays a crucial role in the global transportation network which necessitates a rigorous and continuous inspection to ensure safety. Railway tracks, being exposed to constant stress and environmental factors, are prone to various types of defects such as cracks, misalignments, and wear. Timely detection of these defects is essential to prevent accidents and maintain efficient railway operations. Traditional track inspection methods rely heavily on manual inspections, which are labor-intensive, time-consuming, and prone to human error. With the advancement of technology, automated systems leveraging machine vision and artificial intelligence (AI) have emerged as an alternative for real-time railway track inspection.

However, the problem lies in the ability of these automated systems to process vast amounts of data in real-time while maintaining high accuracy. At high travel speeds, the inspection system must process frames at a rate sufficient to capture and analyze the entire track surface. This challenge is compounded by the need to minimize false positives, which can lead to critical defects being overlooked. Existing solutions may lack a balance between processing speed and detection accuracy. The high-speed AI models generate too many false positives, while the more accurate models cannot process data quickly enough to keep up with the demands of high-speed railway inspections.

Therefore, there is a need for a method and system for detecting defects in track rails that efficiently delivers high throughput while maintaining a low rate of false positives.

### SUMMARY OF THE INVENTION

In an embodiment, a method for detecting defects in track rails is disclosed. The method may include receiving, by a processor, imaging data of one or more-track rails in real-time using an imaging device coupled to a railway train. The method may further include determining, by the processor, a set of image frames of the one or more-track rails for each time instance. In an embodiment, the first AI model may be a lightweight object detection model pretrained based on a first training dataset. In an embodiment, the first training dataset may include a first set of images of track rails corresponding to each of the set of predefined defects. The method may further include processing, by the processor, the first processed frame to determine a second processed frame from the first processed frame based on detection of at least one second defect from the set of predefined defects in the first processed frame using a second AI model. In an embodiment, the second AI model may be a heavyweight object detection model pretrained based on a second training dataset, the second training dataset may include a second set of images of track rails corresponding to each of the set of predefined defects. The method may further include outputting, by the processor, the second processed frame and/or the first processed frame.

In another embodiment, a system for detecting defects in track rails is disclosed. The system may include an imaging device, a processor communicably coupled to the imaging device. The system may further include a memory communicably coupled to the processor, wherein the memory stores processor-executable instructions, which, on execution, cause the processor to receive imaging data of one or more track rails in real-time using an imaging device coupled to a railway train. The processor may further determine a set of image frames of the one or more track rails for each time instance. The processor may further determine a first processed frame from the set of image frames based on detection of at least one first defect from a set of predefined defects in the set of image frames using a first artificial intelligence (AI) model. In an embodiment, the first AI model may be a lightweight object detection model pretrained based on a first training dataset. In an embodiment, the first training dataset may include a first set of images of track rails corresponding to each of the set of predefined defects. The processor may further process the first processed frame to determine a second processed frame from the first processed frame based on detection of at least one second defect from the set of predefined defects in the first processed frame using a second AI model. In an embodiment, the second AI model may be a heavyweight object detection model pretrained based on a second training dataset. In an embodiment, the second training dataset may include a second set of images of track rails corresponding to each of the set of predefined defects. The processor may further output the second processed frame and/or the first processed frame.

It is to be understood that both the foregoing general description and the following detailed description are exemplary and explanatory only and are not restrictive of the invention, as claimed.

### BRIEF DESCRIPTION OF THE DRAWING

The accompanying drawings, which are incorporated in and constitute a part of this disclosure, illustrate exemplary embodiments and, together with the description, serve to explain the disclosed principles.

FIG. 1 illustrates a block diagram of an exemplary system for detecting defects in track rails, in accordance with an embodiment of the present disclosure.

FIG. 2 illustrates a functional block diagram of a computing device, in accordance with an embodiment of the present disclosure.

FIG. 3A illustrates a first processed frame, in accordance with an embodiment of the present disclosure.

FIG. 3B illustrates a second processed frame, in accordance with an embodiment of the present disclosure.

FIG. 4 illustrates a flow diagram of a method for detecting defect in track rails, in accordance with an embodiment of the present disclosure.

FIG. 5 illustrates a flow diagram of a method for training a first Artificial Intelligence (AI) model based on a third training dataset, in accordance with an embodiment of the present disclosure.

FIG. 6 illustrates a flow diagram of another method for training the first AI model based on a third training dataset, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered exemplary only, with the true scope being indicated by the following claims. Additional illustrative embodiments are listed.

Further, the phrases “in some embodiments”, “in accordance with some embodiments”, “in the embodiments shown”, “in other embodiments”, and the like mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope being indicated by the following claims.

Existing system, such as those utilizing machine vision combine with Artificial Intelligence (AI) models may be used in automated track inspection. The high-speed AI models, for instance, is capable of processing data at speeds exceeding 90 frames per second (fps), meeting the real-time requirements for high-speed inspections. However, this comes at the cost of increase false positives, with rates as high as one false positive per mile, which translates into thousands of false alarms daily when scaled across large networks. This number of false positives poses a significant operational burden and increases the risk of missing actual defects.

On the other hand, more accurate AI models significantly reduce the number of false positives, improving the accuracy of defect detection. Despite this improvement, these models may only process data at 25 to 30 fps, which is inadequate for real-time inspection at high speeds, resulting in incomplete coverage and potential oversight of critical track sections.

Accordingly, the present disclosure provides a method and system for detecting defects in track rails, that deliver high throughput while maintaining a low rate of false positives. It is to be noted that the system may be employed in any railway trains including but is not limited to a passenger railway train, a freight railway train, a specialty railway train and any other railway train. For the sake of clarity, the railway train is not shown.

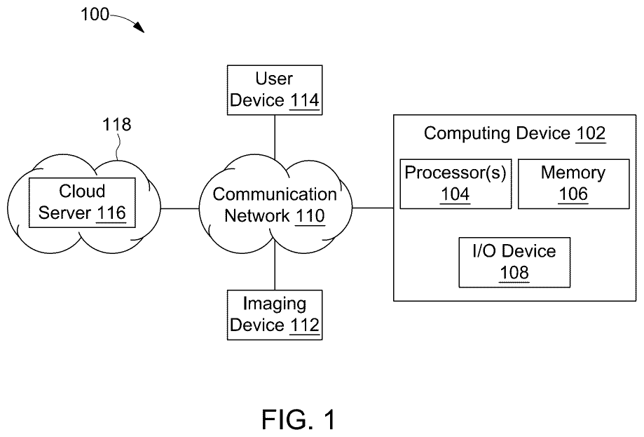

Referring now to FIG. 1, a block diagram of an exemplary system 100 for detecting defects in track rails, in accordance with an embodiment of the present disclosure. The system 100 may include a computing device 102, an imaging device 112 mounted on the railway train, a user device 114, and a cloud server 116 communicably coupled to each other through a wired or wireless communication network 110. The computing device 102 may include a processor 104, a memory 106 and an input/output (I/O) device 108. The processor 104 is responsible for executing the instructions stored in the memory 106.

In an embodiment, examples of processor(s) 104 may include, but are not limited to, an Intel® Itanium® or Itanium 2 processor(s), or AMD® Opteron® or Athlon MP® processor(s), Motorola® lines of processors, Nvidia®, FortiSOC™ system on a chip processors or other future processors.

In an embodiment, the memory 106 may store instructions that, when executed by the processor 104, and cause the processor 104 to detect defects in track rails, as discussed in more detail below. In an embodiment, the memory 106 may be a non-volatile memory or a volatile memory. Examples of non-volatile memory may include, but are not limited to, a flash memory, a Read Only Memory (ROM), a Programmable ROM (PROM), Erasable PROM (EPROM), and Electrically EPROM (EEPROM) memory. Further, examples of volatile memory may include, but are not limited to, Dynamic Random Access Memory (DRAM), and Static Random-Access memory (SRAM).

In an embodiment, the I/O device 108 may comprise of variety of interface(s), for example, interfaces for data input and output devices, and the like. The I/O device 108 may facilitate inputting of instructions by a user communicating with the computing device 102. In an embodiment, the I/O device 108 may be wirelessly connected to the computing device 102 through wireless network interfaces such as Bluetooth®, infrared, or any other wireless radio communication known in the art. In an embodiment, the I/O device 108 may be connected to a communication pathway for one or more components of the computing device 102 to facilitate the transmission of inputted instructions and output results of data generated by various components such as, but not limited to, processor(s) 104.

In an embodiment, the imaging device 112 may be an edge device and responsible for capturing real-time imaging data of track rails. In an embodiment, imaging data of each track rails may be captured independently. The imaging device 112 may include but is not limited to, a vision camera, a 2Dimensional (D)-laser scanner, or other optical sensors capable of capturing detailed images of the track rails at higher speeds. The imaging device 112 continuously captures the imaging data of the track rails as the railway train moves.

In an embodiment, the user device 114 may be used by track rails maintenance personnel to view and interact with defect detection results. The user device 114 may be a standalone device or accessed via a cloud-based application. The user device 114 may allow users to verify defect, review reports, and schedule maintenance activities based on data provided by the computing device 102 and the cloud server 116.

In an embodiment, the cloud server 116 may be enabled in a cloud 118. In an embodiment, the cloud server 116 may include a database (not shown) that may store training data. In an embodiment, the training data may include data that may be used to train the Artificial Intelligence (AI) models. In an embodiment, the database may store data input by the imaging device 112 or output generated by the computing device 102.

In an embodiment, the communication network 110 may be a wired or a wireless network or a combination thereof. The communication network 110 can be implemented as one of the different types of networks, such as but not limited to, ethernet IP network, intranet, local area network (LAN), wide area network (WAN), the internet, Wi-Fi, LTE network, CDMA network, 5G and the like. Further, the communication network 110 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the communication network 110 can include a variety of network devices, including routers, bridges, servers, computing devices, storage devices, and the like.

In an embodiment, the computing device 102 may receive a user input for detecting defects in track rails from the user device 114 through the communication network 110. In an embodiment, the computing device 102 and the user device 114 may be a computing system, including but not limited to, a smart phone, a laptop computer, a desktop computer, a notebook, a workstation, a portable computer, a handheld, a scanner, or a mobile device. In an embodiment, the computing device 102 may be, but not limited to, in-built into the imaging device 112 or may be a standalone computing device.

In an embodiment, entire defect detection may occur on the imaging device 112, with only the final results transmitted to the cloud server 116. This embodiment reduces reliance on network connectivity and allows for faster defect detection. In another embodiment, the imaging device 112 may perform preliminary defect detection and then the cloud-server 116 may perform secondary defect detection for detailed analysis. This embodiment balances processing load and network bandwidth usage.

In an embodiment, the computing device 102 may perform various processing in order to detect defects in track rails. By way of an example, the computing device 102 may receive imaging data of one or more track rails in real-time from the imaging device 112 via the I/O device 108. In an embodiment the one or more track rails may include a left track rail and a right track rail. The computing device 102 may further determine a set of image frames of the one or more track rails for each time instance. In an embodiment, the set of image frames may include at least one left rail image of the left track rail and at least one right rail image of the right track rail. The set of image frames may be saved in a raw queue. In an embodiment, the at least one left rail image may be saved in a left raw queue and the at least one right rail image may be saved in a right raw queue.

The computing device 102 may further determine a first processed frame from the set of image frames based on detection of at least one first defect from a set of predefined defects in the set of image frames using a first artificial intelligence (AI) model. In an embodiment, the first AI model may process frames at high speeds of frames per second, thus enabling real-time defect detection. In an embodiment, the set of predefined defects may include but are not limited to, a crack, a railhead wear, a misaligned part, a missed part and other types of structural abnormalities. In an embodiment, example of the first AI model may be, but is not limited to, a variant of You Only Look Once (YOLO) model, such as YOLO-Tiny. In an embodiment, the first AI model may be a lightweight object detection model that may be pretrained based on a first training dataset. The first training dataset may include a first set of images of track rails corresponding to each of the set of predefined defects.

The computing device 102 may further process the first processed frame to determine a second processed frame from the first processed frame based on a detection of at least one second defect from the set of predefined defects in the first processed frame using a second AI model. In an embodiment, the first processed frame may be processed by the second AI model in case at least one of a real-time speed of the railway train may be less than a first predefined threshold or a free space associated with the raw queue may be more than a second predefined threshold. In an embodiment, the second AI model may process frames at high accuracy and in detail, thus reducing false positives generated by the first AI model. In an embodiment, examples of the second AI model may be, but is not limited to, an advanced variant of the YOLO model, such as YOLOv5. In an embodiment, the second AI model may be a heavyweight object detection model pretrained based on a second training dataset. In an embodiment, the second training dataset may include a second set of images of track rails corresponding to each of the predefined defects.

The computing device 102 may further output the second processed frame and/or the first processed frame to the user device 114. In an embodiment, the computing device 102 may output the second processed frame to the user device 114 and in addition to the second processed frame, the computing device 102 may also output the first processed frame to the user device 114. In an embodiment, the computing device 102 may transmit the second processed frame and/or the first processed frame to the cloud server 116. In an embodiment, the computing device 102 may transmit the second processed frame to the cloud server 116 and in addition to the second processed frame, the computing device 102 may also transmit the first processed frame to the cloud server 116. The cloud server 116 may compare the first processed frame and the second processed frame to determine at least one false positive based on a mismatch in the at least one first defect in the first processed frame and the at least one second defect in the second processed frame. The cloud server 116 may further determine a third training dataset for training the first AI model based on the at least one false positive.

Alternatively, the computing device 102 may further transmit the at least one first defect in the first processed frame and the at least one second defect in the second processed frame on the user device 114 communicably connected to the cloud server 116. The cloud server 116 may determine at least one false positive based on receiving a user feedback via the user device 114 indicating at least one false positive based on a mismatch in the at least one first defect in the first processed frame and the at least one second defect in the second processed frame. The cloud server 116 may further determine a third training dataset for training the first AI model based on the at least one false positive. In an embodiment, the first AI model may continuously improve its detection capabilities by updating its dataset with the third training dataset based on new defects detected in the frames and user feedback.

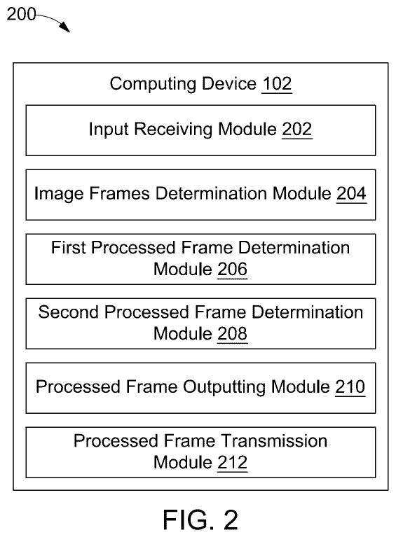

Referring now to FIG. 2, a functional block diagram of the computing device 102 is illustrated, in accordance with an embodiment of the present disclosure. In an embodiment, the computing device 102 may include an input receiving module 202, an image frames determination module 204, a first processed frame determination module 206, a second processed frame determination module 208, a processed frame outputting module 210 and a processed frame transmission module 212.

The input receiving module 202 may receive imaging data of one or more track rails using the imaging device 112 via the I/O device 108. In an embodiment the one or more track rails may include a left track rail and a right track rail. Further, the image frames determination module 204 may determine a set of image frame of the one or more track rails for each time instance. In an embodiment, the set of image frames may include at least one left rail image of the left track rail and at least one right rail image of the right track rail. The set of image frames may be saved in a raw queue. In an embodiment, the at least one left rail image may be saved in a left raw queue and the at least one right image may be saved in a right raw queue.

The first processed frame determination module 206 may determine a first processed frame from the set of image frames based on detection of at least one first defect from a set of predefined defects in the set of image frames using a first artificial intelligence (AI) model. In an embodiment, the first AI model may process frames at high speeds of frames per second, thus enabling real-time defect detection. In an embodiment, the set of predefined defects may include but are not limited to, a crack, a railhead wear, a misaligned part, a missed part and other types of structural abnormalities. In an embodiment, example of the first AI model may be, but is not limited to, a variant of You Only Look Once (YOLO) model, such as YOLO-Tiny. In an embodiment, the first AI model may be a lightweight object detection model that may be pretrained based on a first training dataset. The first training dataset may include a first set of images of track rails corresponding to each of the set of predefined defects.

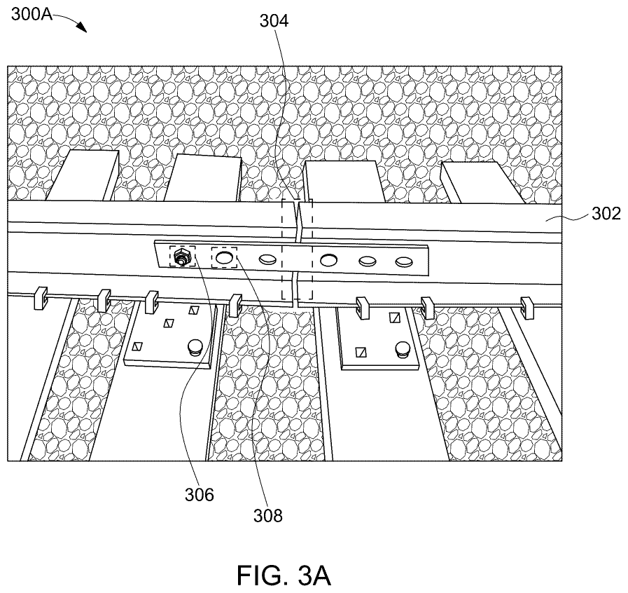

Referring now to FIG. 3A, the first processed frame 300A is illustrated, in accordance with an embodiment of the present disclosure. The first processed frame 300A may represent an image frame of a track rail 302, that has been processed using the first AI model to detect defects in the track rail 302. In an embodiment, the track rail 302 may be any of the left track rail or the right track rail.

Within the first processed frame 300A, the first AI model has identified at least one first object. The at least one first object may include, but is not limited to, a nut, a bolt, a rail gap, No Fastner, etc. The first processed frame 300A may include bounding boxes 304-308 that indicate regions where the first AI model has detected the at least one first object. As can be seen in the FIG. 3A, the bounding box 304 may represent a rail gap in the track rail 302 as the at least one first object, also the bounding boxes 306 and 308 may represent nut and bolt respectively in the track rail 302 as the at least one first object.

The first AI model may classify each bounding box 304-308 within the first processed frame 300A with a classification label that may specify a type of at least one object. For example, a “Rail Gap” label may be associated with the bounding box 304, a “nut” label may be associated with the bounding box 306 and a “bolt” label may be associated with the bounding box 308. The first AI model may also determine confidence scores associated with each bounding box 304-308. These scores, which may range from 0 to 1, represent confidence of the first AI model in its object detection accuracy. For example, a confidence score of 0.75 associated with the “Rail Gap” label, indicating that the first AI model may be 75% confident that the detected defect is indeed a Rail Gap. Further, the first AI model may detect at least one first defect based on the identified at least one first object. The at least one first defect may include, but is not limited to, a crack, a pull-apart, a railhead wear, a mild-priority defect, a misaligned part, a missed part and other types of structural abnormalities. In accordance with the FIG. 3A, the first AI model may detect the at least one first defect as a pull-apart defect, which may be a severe fault.

Referring back to FIG. 2, the second processed frame determination module 208 may process the first processed frame to determine a second processed frame from the first processed frame based on a detection of at least one second defect from the set of predefined defects in the first processed frame using a second AI model. In an embodiment, the first processed frame may be further processed by the second AI model in case at least one of a real-time speed of the railway train may be less than a first predefined threshold or a free space associated with the raw queue that may be more than a second predefined threshold. In an embodiment, the second AI model may process frames at high accuracy and in detail, thus reducing false positives generated by the first AI model. In an embodiment, examples of the second AI model may be, but is not limited to, an advanced variant of the YOLO model, such as YOLOv5. In an embodiment, the second AI model may be a heavyweight object detection model pretrained based on a second training dataset. In an embodiment, the second training dataset may include a second set of images of track rails corresponding to each of the set of predefined defects.

Referring now to FIG. 3B, the second processed frame 300B is illustrated, in accordance with an embodiment of the present disclosure. The second processed frame 300B may be generated after processing the first processed frame 300A using the second AI model. This processing of the first processed frame 300A is to refine the detection of defects by reducing false positives. In an embodiment, the second processed frame 300B may include at least one second object that may differ from the at least one first object in the first processed frame 300A which reflects the refined detection outcomes of the second AI model.

In the first processed frame 300A, the bounding box 304 for the at least one first object (i.e., Rail Gap), remains in the second processed frame 300B as the at least one second object but identified as a “Rail Joint”. The second AI model has confirmed the presence of the “Rail Joint” with a higher confidence score than the first AI model has for the “Rail Gap”. The bounding boxes 306 and 308 may be generated by the first AI model to highlight the at least one first object, remains in the second processed frame 300B as the at least one second object and identified as “nut” and “bolt” respectively. The second processed frame 300B may also include a bounding box 310 that indicates a region where the second AI model has detected a “bolt” as the at least one second object which is not present in the first processed frame 300A. This indicates that the initial detection of defects by the first AI model may not meet criteria for the at least one second defect when analyzed with the second AI model.

The second AI model has confirmed the presence of the at least one second object with a higher confidence score than the first AI model has for the at least one first object. The second AI model, with its more detailed analysis, successfully identifies or confirms the presence of these objects to ensure these objects may be brought to the attention of maintenance teams.

The second AI model may also determine confidence scores associated with each bounding box 304-310. These scores, which may also range from 0 to 1, represent confidence of the second AI model in its object detection accuracy. For example, a confidence score of 0.99 associated with the “Rail Joint” label, confirms the presence of the detected object is indeed a Rail Joint. Furthermore, the second AI model may detect at least one second defect based on the identified at least one second object. In accordance with the FIG. 3B, the second AI model may detect the at least one second defect as a mild-priority defect.

Referring back to FIG. 2, the processed frame outputting module 210 may further output the second processed frame and/or the first processed frame to the user device 114. In an embodiment, the processed frame outputting module 210 may output the second processed frame to the user device 114 and in addition to the second processed frame, the processed frame outputting module 210 may also output the first processed frame to the user device 114. In accordance with the FIGS. 3A and 3B, the processed frame outputting module 210 may further output the second processed frame 300B and/or the first processed frame 300A to the user device 114.

Referring back to FIG. 2, the processed frame transmission module 212 may transmit the second processed frame and/or the first processed frame to the cloud server 116. In an embodiment, the processed frame transmission module 212 may transmit the second processed frame to the user device 114 and in addition to the second processed frame, the processed frame transmission module 212 may also transmit the first processed frame to the user device 114. The cloud server 116 may compare the first processed frame and the second processed frame to determine at least one false positive based on a mismatch in the at least one first defect in the first processed frame and the at least one second defect in the second processed frame. The cloud server 116 may further determine a third training dataset for training the first AI model based on the at least one false positive. In accordance with the FIGS. 3A and 3B, the processed frame transmission module 212 may transmit the second processed frame 300B and/or the first processed frame 300A to the cloud server 116. In an embodiment, the processed frame transmission module 212 may transmit the second processed frame 300B to the user device 114 and in addition to the second processed frame 300B, the processed frame transmission module 212 may also transmit the first processed frame 300A to the user device 114. The cloud server 116 may compare the first processed frame 300A and the second processed frame 300B. This comparison may highlight differences between the first processed frame 300A and the second processed frame 300B, such the presence of false positives (i.e., bounding boxes 306 and 308) and confirmed the presence of defects (i.e., bounding boxes 304, 310, 312 and 314). The cloud server 116 may further determine a third training dataset for training the first AI model based on the false positives.

Referring back to FIG. 2, alternatively the processed frame transmission module 212 may transmit the at least one first defect in the first processed frame and the at least one second defect in the second processed frame on the user device 114 communicably connected to the cloud server 116. The cloud server 116 may determine at least one false positive based on receiving a user feedback via the user device 114 indicating at least one false positive based on a mismatch in the at least one first defect in the first processed frame and the at least one second defect in the second processed frame. The cloud server 116 may further determine a third training dataset for training the first AI model based on the at least one false positive. In accordance with the FIGS. 3A and 3B, the processed frame transmission module 212 may transmit the at least one first defect in the first processed frame 300A and the at least one second defect in the second processed frame 300B on the user device 114 communicably connected to the cloud server 116. The cloud server 116 may determine the presence of false positives (i.e., bounding boxes 306 and 308) and confirmed the presence of defects (i.e., bounding boxes 304, 310, 312 and 314) based on receiving the user feedback via the user device 114 indicating the false positives based on the mismatch in the at least one first defect in the first processed frame 300A and the at least one second defect in the second processed frame 300B.

The accuracy and reliability of defect detection in railway track inspection may be significantly enhanced by using the second AI model in conjunction with the first AI model. Based on various experiments conducted, the performance metrics of the first AI model and the second AI model across the set of predefined defects is as follows:
“For detecting defects in the track rail joints, the first AI model may attain 99.2% precision, 89.4% recall, and 96.4% accuracy. The second AI model may further enhance performance, achieving 100.0% precision, 95.5 % recall, and 96.8% accuracy, reflecting a 6.1% increase in recall and a 2.1% improvement in accuracy.”
“For detecting missing bolts in the track rails as defects, the first AI model may attain 38.6% precision, with 85.0% recall and 92.9% accuracy. The second AI model may significantly improve precision to 70.4%, recall to 95.0%, and accuracy to 97.9%, leading to an impressive enhancement of 31.7% in precision and 5.0% in accuracy.”

Accordingly, the performance data clearly represents that the second AI model provides superior accuracy, recall, and precision across all classes of defects compared to the first AI model. The significant improvements in accuracy, recall, and precision in particular, indicate that the first AI model is far more effective at detecting false positives and true positives, thereby reducing the likelihood of missing critical defects. Therefore, the use of a combination of the first AI model and the second AI model as per the present disclosure may lead to higher accuracy in detection of defects as compared to detection by individual AI models. This enhanced accuracy is crucial for ensuring the safety and reliability of railway operations, as it minimizes the risk of undetected defects that could potentially lead to accidents or operational failures.

It should be noted that all such aforementioned modules 202-212 may be represented as a single module or a combination of different modules. Further, as will be appreciated by those skilled in the art, each of the modules 202-212 may reside, in whole or in parts, on one device or multiple devices in communication with each other. In some embodiments, each of the modules 202-212 may be implemented as dedicated hardware circuit comprising custom application-specific integrated circuit (ASIC) or gate arrays, off-the-shelf semiconductors such as logic chips, transistors, or other discrete components. Each of the modules 202-212 may also be implemented in a programmable hardware device such as a field programmable gate array (FGPA), programmable array logic, programmable logic device, and so forth. Alternatively, each of the modules 202-212 may be implemented in software for execution by various types of processors (e.g. processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for detecting defects in track rails. For example, the exemplary system 100 and the associated computing device 102 may detect defects in track rails by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

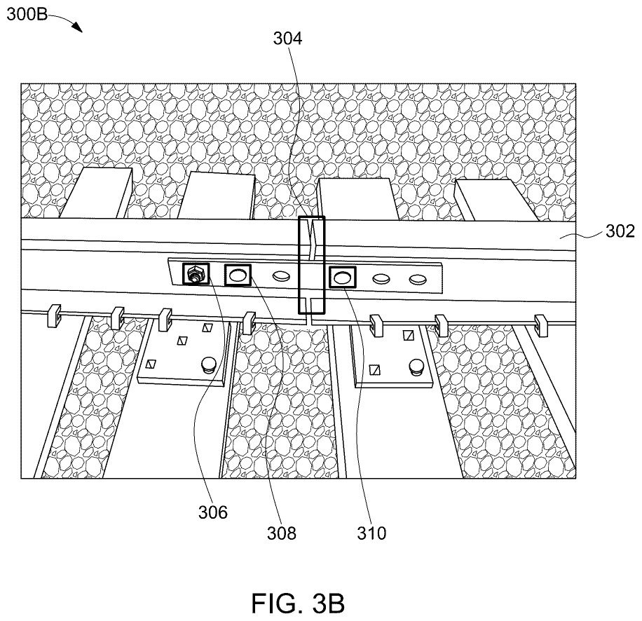

Referring now to FIG. 4, a flow diagram of a method 400 of detecting defects in track rails is illustrated, in accordance with an embodiment of present disclosure. In an embodiment, the method 400 may include a plurality of steps that may be performed by the processor 104 to detect anomalies in track rails. FIG. 4 is explained in conjunction with FIGS. 1 and 2. Each step of the method 400 may be executed by various modules of the computing device 102.

At step 402, imaging data of one or more track rails may be received in real-time using the imaging device 112 via the I/O device 108. In an embodiment the one or more track rails may include a left track rail and a right track rail. Further at step 404, a set of image frames of the one or more track rails may be determined for each time instance. In an embodiment, the set of image frames may include at least one left rail image of the left track rail and at least one right rail image of the right track rail. The set of image frames may be saved in a raw queue. In an embodiment, the at least one left rail image may be saved in a left raw queue and the at least one right rail image may be saved in a right raw queue.

Further at step 406, a first processed frame may be determined from the set of image frames based on detection of at least one first defect from a set of predefined defects in the set of image frames using a first artificial intelligence (AI) model. In an embodiment, the first AI model may be a lightweight object detection model pretrained based on a first training dataset. In an embodiment, the first training dataset may include a first set of images of track rails corresponding to each of the set of predefined defects.

Further, at step 408, the first processed frame may be processed to determine a second processed frame from the first processed frame based on detection at step 410, of at least one second defect from the set of predefined defects in the first processed frame using a second AI model. In an embodiment, the second AI model may be a heavyweight object detection model pretrained based on a second training dataset. In an embodiment, the second training dataset may include a second set of images of track rails corresponding to each of the set of predefined defects. In an embodiment, the first processed frame may be processed by the second AI model in case at least one of a real-time speed of the railway train may be less than a first predefined threshold or a free space associated with the raw queue may be more than a second predefined threshold. Further, at step 412, the second processed frame and/or the first processed frame may be output to the user device 114.

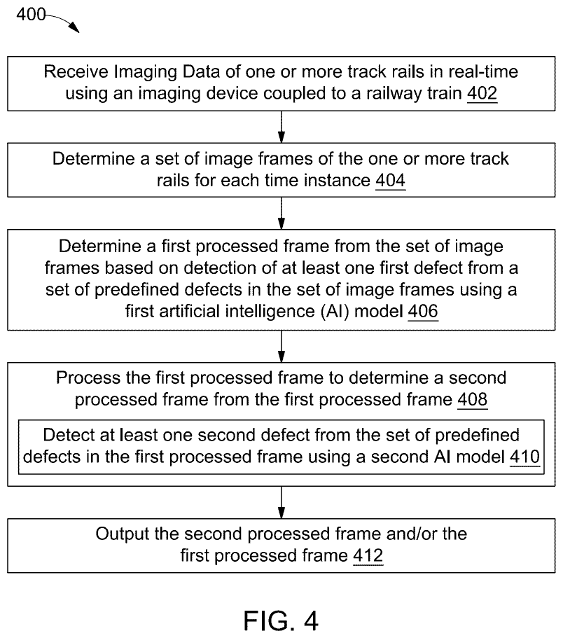

Referring now to FIG. 5, a flow diagram of a method 500 for training the first AI model based on a third training dataset is illustrated, in accordance with an embodiment of present disclosure. In an embodiment, the method 500 may include a plurality of steps that may be performed either by the cloud server 116 or by the processor 104 to train the first AI model. FIG. 5 is explained in conjunction with FIGS. 1, 2 and 4. Each step of the method 500 may be executed either by the cloud server 116 or by various modules of the computing device 102.

At step 502, the second processed frame and/or the first processed frame may be transmitted to the cloud server 116. Further at step 504, the first processed frame and the second processed frame may be compared to determine at least one false positive based on a mismatch in the at least one first defect in the first processed frame and the at least one second defect in the second processed frame. Further at step 506, the third training dataset may be determined for training the first AI model based on at least one false positive.

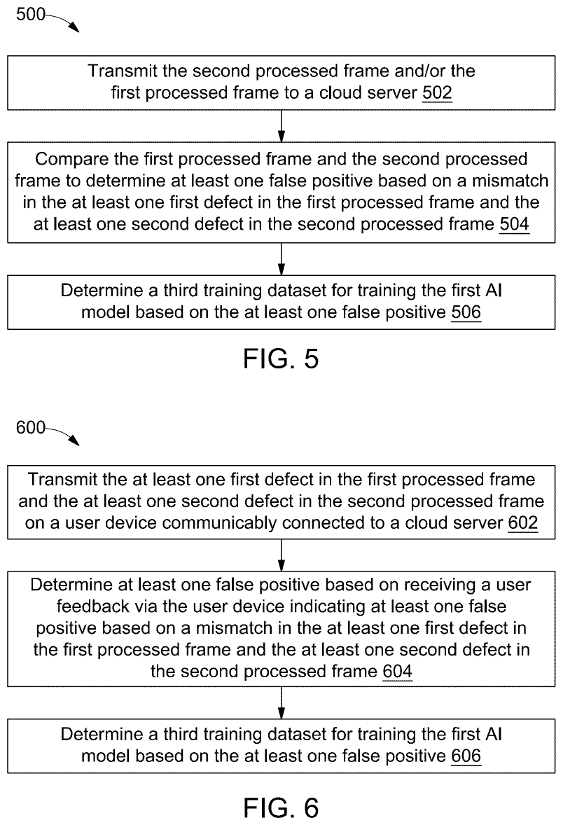

Referring now to FIG. 6, a flow diagram of another method 600 for training the first AI model based on a third training dataset is illustrated, in accordance with an embodiment of present disclosure. In an embodiment, the method 600 may include a plurality of steps that may be performed either by the cloud server 116 or by the processor 104 to train the first AI model. FIG. 6 is explained in conjunction with FIGS. 1, 2 and 4. Each step of the method 600 may be executed either by the cloud server 116 or various modules of the computing device 102.

At step 602, the at least one first defect in the first processed frame and the at least one second defect in the second processed frame may be transmitted on the user device 114 communicably connected to the cloud server 116.

Further at step 604, at least one false positive may be determined based on receiving a user feedback via the user device 114 indicating at least one false positive based on a mismatch in the at least one first defect in the first processed frame and the at least one second defect in the second processed frame. Further at step 606, the third training dataset for training the first AI model based on the at least one false positive.

Thus, the disclosed method 400 and system 100 tries to overcome the technical problem of railway track rails inspection through a method and system of detecting defects in track rails. In an embodiment, advantages of the disclosed method 400 and system 100 may include but are not limited to, the disclosed method 400 and system 100 enhance the accuracy of defect detection in track rails by employing two-stage AI processing approach. The initial lightweight AI model quickly identifies potential defects, while the heavy weight AI model refines the results, reducing false positives and ensuring that critical defects are not missed.

Further, the disclosed method 400 and system 100 is designed to process imaging data in real-time, even at high train speeds. By leveraging the heavyweight AI model for secondary analysis, the disclosed method 400 and system 100 significantly reduces the number of false positives generated. This reduction of the false positives minimizes unnecessary maintenance interventions.

As will be appreciated by those skilled in the art, the techniques described in the various embodiments discussed above are not routine, or conventional, or well-understood in the art. The techniques discussed above provide for detecting defects in track rails.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described method and system for detecting defects in track rails. The illustrated steps are set out to explain the exemplary embodiments shown, and it should be anticipated that ongoing technological development will change the manner in which particular functions are performed. These examples are presented herein for purpose of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

It is intended that the disclosure and examples be considered as exemplary only, with a true scope of disclosed embodiments being indicated by the following claims.

What is claimed is:

1. A method for detecting defects in track rails, the method comprising:
receiving, by a processor, imaging data of one or more-track rails in real-time using an imaging device coupled to a railway train;
determining, by the processor, a set of image frames of the one or more-track rails for each time instance;
determining, by the processor, a first processed frame from the set of image frames based on detection of at least one first defect from a set of predefined defects in the set of image frames using a first artificial intelligence (AI) model,
wherein the first AI model is a lightweight object detection model pretrained based on a first training dataset, the first training dataset comprising a first set of images of track rails corresponding to each of the set of predefined defects;
processing, by the processor, the first processed frame to determine a second processed frame from the first processed frame based on:
detecting, by the processor, at least one second defect from the set of predefined defects in the first processed frame using a second AI model,
wherein the second AI model is a heavyweight object detection model pretrained based on a second training dataset, the second training dataset comprising a second set of images of track rails corresponding to each of the set of predefined defects; and
outputting, by the processor, the second processed frame and/or the first processed frame.

2. The method of claim 1, wherein the set of image frames comprises at least one left rail image and at least one right rail image, and wherein the set of image frames are saved in a raw queue.

3. The method of claim 2, wherein the first processed frame is processed by the second AI model in case at least one of: a real-time speed of the railway train is less than a first predefined threshold or a free space associated with the raw queue is more than a second predefined threshold.

4. The method of claim 1, comprising:
transmitting, by the processor, the second processed frame and/or the first processed frame to a cloud server;
comparing, by the cloud server, the first processed frame and the second processed frame to determine at least one false positive based on a mismatch in the at least one first defect in the first processed frame and the at least one second defect in the second processed frame; and
determining, by the cloud server, a third training dataset for training the first AI model based on the at least one false positive.

5. The method of claim 1, comprising:
transmitting, by the processor, the at least one first defect in the first processed frame and the at least one second defect in the second processed frame on a user device communicably connected to a cloud server;
determining, by the cloud server, at least one false positive based on receiving a user feedback via the user device indicating at least one false positive based on a mismatch in the at least one first defect in the first processed frame and the at least one second defect in the second processed frame; and
determining, by the cloud server, a third training dataset for training the first AI model based on the at least one false positive.

6. A system for detecting defects in track rails, comprising:
an imaging device coupled to a railway train;
a processor communicably coupled to the imaging device; and
a memory communicably coupled to the processor, wherein the memory stores processor-executable instructions, which, on execution, cause the processor to:
receive imaging data of one or more-track rails in real-time using the imaging device;
determine a set of image frames of the one or more-track rails for each time instance;
determine a first processed frame from the set of image frames based on detection of at least one first defect from a set of predefined defects in the set of image frames using a first artificial intelligence (AI) model,
wherein the first AI model is a lightweight object detection model pretrained based on a first training dataset, the first training dataset comprising a first set of images of track rails corresponding to each of the set of predefined defects;
process the first processed frame to determine a second processed frame from the first processed frame based on:
detection of at least one second defect from the set of predefined defects in the first processed frame using a second AI model,
wherein the second AI model is a heavyweight object detection model pretrained based on a second training dataset, the second training dataset comprising a second set of images of track rails corresponding to each of the set of predefined defects; and
output the second processed frame and/or the first processed frame.

7. The system of claim 6, wherein the set of image frames comprises at least one left rail image and at least one right rail image, and wherein the set of image frames are saved in a raw queue.

8. The system of claim 7, wherein the first processed frame is processed by the second AI model in case at least one of: a real-time speed of the railway train is less than a first predefined threshold or a free space associated with the raw queue is more than a second predefined threshold.

9. The system of claim 6, wherein the processor executable instructions cause the processor to:
transmit the second processed frame and/or the first processed frame to a cloud server; and
wherein the cloud server is configured to:
compare the first processed frame and the second processed frame to determine at least one false positive based on a mismatch in the at least one first defect in the first processed frame and the at least one second defect in the second processed frame; and
determine a third training dataset for training the first AI model based on the at least one false positive.

10. The system of claim 6, wherein the processor executable instructions cause the processor to:
transmit the at least one first defect in the first processed frame and the at least one second defect in the second processed frame on a user device communicably connected to a cloud server; and
wherein the cloud server is configured to:
determine at least one false positive based on receiving a user feedback via the user device indicating at least one false positive based on a mismatch in the at least one first defect in the first processed frame and the at least one second defect in the second processed frame; and
determine a third training dataset for training the first AI model based on the at least one false positive.

11. A non-transitory computer-readable medium storing computer-executable instructions for detecting defects in track rails, the computer-executable instructions configured for:
receiving imaging data of one or more-track rails in real-time using an imaging device coupled to a railway train;
determining a set of image frames of the one or more-track rails for each time instance;
determining a first processed frame from the set of image frames based on detection of at least one first defect from a set of predefined defects in the set of image frames using a first artificial intelligence (AI) model,
wherein the first AI model is a lightweight object detection model pretrained based on a first training dataset, the first training dataset comprising a first set of images of track rails corresponding to each of the set of predefined defects;
processing the first processed frame to determine a second processed frame from the first processed frame based on:
detecting at least one second defect from the set of predefined defects in the first processed frame using a second AI model,
wherein the second AI model is a heavyweight object detection model pretrained based on a second training dataset, the second training dataset comprising a second set of images of track rails corresponding to each of the set of predefined defects; and
outputting the second processed frame and/or the first processed frame.

12. The non-transitory computer-readable medium of claim 11, wherein the set of image frames comprises at least one left rail image and at least one right rail image, and wherein the set of image frames are saved in a raw queue.

13. The non-transitory computer-readable medium of claim 12, wherein the first processed frame is processed by the second AI model in case at least one of: a real-time speed of the railway train is less than a first predefined threshold or a free space associated with the raw queue is more than a second predefined threshold.

14. The non-transitory computer-readable medium of claim 11, wherein the computer-executable instructions are further configured for:
transmitting the second processed frame and/or the first processed frame to a cloud server;
wherein the first processed frame and the second processed frame are compared by the cloud server, to determine at least one false positive based on a mismatch in the at least one first defect in the first processed frame and the at least one second defect in the second processed frame, and
wherein a third training dataset is determined by the cloud server, for training the first AI model based on the at least one false positive.

15. The non-transitory computer-readable medium of claim 11, wherein the computer-executable instructions are further configured for:
transmitting the at least one first defect in the first processed frame and the at least one second defect in the second processed frame on a user device communicably connected to a cloud server;
wherein at least one false positive is determined by the cloud server based on receiving a user feedback via the user device indicating at least one false positive based on a mismatch in the at least one first defect in the first processed frame and the at least one second defect in the second processed frame, and
wherein a third training dataset is determined by the cloud server, for training the first AI model based on the at least one false positive.
